(19) United States
(12) Patent Application Publication
(10) Pub. No.: US 2013/0030765 A1
(43) Pub. Date: Jan. 31, 2013

(54) SYSTEM AND METHOD FOR USE IN MONITORING MACHINES

(71) Applicant: Danni David, Mumbai (IN)

(72) Inventor: Danni David, Mumbai (IN)

(21) Appl. No.: 13/191,946

(22) Filed: Jul. 27, 2011

(51) Int. Cl. G06F 15/00

(52) U.S. Cl. 702/183

(57) ABSTRACT

A system for monitoring a machine includes a memory device operatively coupled with a processor. The memory device stores a plurality of operational measurements of the machine and is programmed with computer instructions that instruct the processor to record a first plurality of operational measurements of the machine, perform a full spectrum analysis thereof, and generate a first full spectrum data set therefrom. The instructions also instruct the processor to transmit the first full spectrum data set to a model stored within the memory device. The instructions further instruct the processor to determine variations between the first full spectrum data set and a second full spectrum data set. The second full spectrum data set is different from the first full spectrum data set.

### BACKGROUND OF THE INVENTION

The subject matter disclosed herein relates generally to monitoring systems and, more specifically, to systems and methods for use in monitoring the physical condition of a machine.

Many known industrial facilities include a plurality of known rotating and reciprocating machines. At least some such known machines include turbomachines, pumps, motors, compressors, diesel engines, gear boxes, and fans. At least some of such known industrial facilities are power generation facilities that include at least some of the known turbomachines, such as gas turbine engines and steam turbogenerators.

Many known machines include components that receive monitoring equipment for real-time data acquisition and off-line diagnostics. Such known components include, for example, rotatable shafts and associated bearings. Also, such known monitoring equipment includes, for example, proximity probes, vibration sensors and temperature sensors. During routine and non-routine operation of the machines, the monitoring equipment transmits a voluminous amount of real-time data to a Supervisory Control and Data Acquisition (SCADA) system and/or a Data Acquisition System (DAS).

During operation of some of these known machines, the machines may experience deviations from normal operation. Some of these deviations are anomalies that do not initiate any alerts, warnings, or alarms. The machines may return to their normal operational parameters after a brief display of the anomaly. Moreover, such anomalies may not be recognized during a review of the data collected during the anomalies, if the data is reviewed at all, and the anomalies will remain unnoticed and unexplained. These anomalies may be indicative of impending, more severe deviations from normal operation, including sudden and/or catastrophic failure of the machine. In the event of such a failure of the machine, the indications of the earlier unnoticed anomalies may once again be overlooked during a review of historical data recorded through the operational life of the machine. Therefore, operators of the machine may remain unwary of certain behaviors and/or conditions of the machine that may indicate a potentially pending, or imminent, failure. Moreover, such historical data reviews are time-consuming, resource-intensive, and, therefore, expensive.

Operators within some of the known facilities have formed computer-implemented models of some of the known machines to facilitate identification, notification, and diagnosis of faults. Some of these known computer-implemented models are generated by first principles based on empirical data. Alternatively, some of these known models are generated with a spectral analysis of some of the waveform data to create deterministic models that are used to diagnose faults in the machines. A Fast Fourier Transformation (FFT) is used to transfer the recorded waveform data from the time domain to the frequency domain. Typically, the transformed waveform data used is limited to frequency data and amplitude data. Further, alternatively, some known computer-implemented models use empirical process information and/or use the spectral analysis information that merely includes the frequency data and amplitude data of the collected waveform data.

Such computer-implemented models may be generated by modeling techniques that include neural networks, a clustering model, and/or a support vector machine. These known computer-implemented models may not be generated with sufficient spectral analysis data and/or empirical data to fully and accurately define the machine, the associated processes, and/or associated faults. Moreover, limiting the real-time analysis of spectral data to frequencies and amplitudes of the collected waveforms extends the analysis time and/or response time of the model, thereby delaying responses by the operators. Furthermore, the use of limited spectral data increases the reliance on the use of empirical data to generate the models, thereby increasing the complexity of the models, and therefore increasing the maintenance requirements of the models.

### BRIEF DESCRIPTION OF THE INVENTION

In one aspect, a system for monitoring a machine is provided. The system for monitoring a machine includes at least one memory device configured to store a plurality of operational measurements of the machine being monitored. Each operational measurement is associated with a time. The system also includes at least one processor coupled with the at least one memory device. The at least one memory device includes programmed computer instructions that instruct the at least one processor to record a first plurality of operational measurements of the machine and perform a full spectrum analysis of the first plurality of operational measurements of the machine and generate a first full spectrum data set therefrom. The at least one memory device also includes programmed computer instructions that instruct the at least one processor to transmit the first full spectrum data set to at least one model stored within the at least one memory device and determine variations between the first full spectrum data set and a second full spectrum data set. The second full spectrum data set is different from the first full spectrum data set.

In another aspect, a method for use in monitoring a machine is provided. The method includes recording, by a computing device, a plurality of first operational measurements of the machine being monitored while the machine in a predetermined operating condition. The method also includes associating, by the computing device, the plurality of first operational measurements with the predetermined operating condition of the machine. The method further includes performing, by the computing device, a full spectrum analysis of the plurality of first operational measurements of the machine and generating a first full spectrum data set therefrom. The method also includes transmitting, by the computing device, the first full spectrum data set to at least one model stored within the computing device. The method further includes determining, by the computing device, variations between the first full spectrum data set and a second full spectrum data set, wherein the second full spectrum data set is different from the first full spectrum data set.

In yet another aspect, one or more non-transitory computer-readable storage media having computer-executable instructions embodied thereon is/are provided. When executed by at least one processor, the computer-executable instructions cause the at least one processor to communicate with at least one memory device to cause the at least one memory device to store and retrieve a plurality of first operational measurements of a machine. Each operational measurement is associated with a time and the machine is in a predetermined operating condition. Also, when executed by at least one processor, the computer-executable instructions cause the at least one processor to record a plurality of first operational measurements of the machine, associate the plurality of first operational measurements with the predetermined operating condition of the machine, perform a full spectrum analysis of the plurality of first operational measurements of the machine and generate a first full spectrum data set therefrom, and transmit the first full spectrum data set to at least one model stored within the at least one memory device. Also, when executed by at least one processor, the computer-executable instructions cause the at least one processor to determine variations between the first full spectrum data set and a second full spectrum data set. The second full spectrum data set is different from the first full spectrum data set.

### BRIEF DESCRIPTION OF THE DRAWINGS

FIG. 1 is a simplified block diagram of a typical server architecture that may be used to monitor and/or control the operation of a machine;

FIG. 2 is a block diagram of an exemplary configuration of a user computer device that may be used to monitor and/or control the operation of a machine;

FIG. 3 is a block diagram of an exemplary configuration of a server computer device that may be used to monitor and/or control the operation of a machine;

FIG. 4 is block diagram of an exemplary combustion engine monitoring system that includes a combustion engine, a combustion engine controller, and a neural network coupled in communication via a network;

FIG. 5 is a flowchart of an exemplary method that may be implemented to monitor and evaluate operation of the synchronous machine shown in FIGS. 3 and 4; and

FIG. 6 is a continuation of the flowchart from FIG. 5.

### DETAILED DESCRIPTION OF THE INVENTION

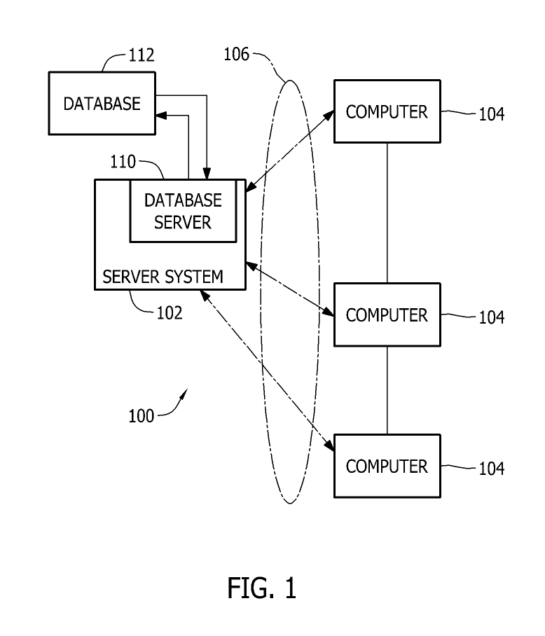

FIG. 1 is a simplified block diagram of a typical server architecture of a monitoring system 100. In the exemplary embodiment, monitoring system 100 facilitates collecting, storing, and displaying data associated with operation of machines (not shown) in an industrial facility (not shown). Also, in the exemplary embodiment, monitoring system 100 includes a server system 102 communicatively coupled to a plurality of client systems 104, which may include one or more input devices (not shown in FIG. 1).

Further, in the exemplary embodiment, client systems 104 are computers that include a web browser, which enable client systems 104 to access server system 102 using a communications network 106 integrated within monitoring system 100. At least a portion of communications network 106 forms a backbone of monitoring system 100. More specifically, client systems 104 are communicatively coupled to server system 102 through at least one of many possible interfaces including, without limitation, at least one of the Internet, a local area network (LAN), a wide area network (WAN), and/or an integrated services digital network (ISDN), a dial-up-connection, a digital subscriber line (DSL), a cable modem, a mesh network, and/or a virtual private network (VPN). Client systems 104 can be any device capable of accessing server system 102 including, without limitation, a desktop computer, a laptop computer, a personal digital assistant (PDA), a smart phone, or other web-based connectable equipment.

Also, in the exemplary embodiment, a database server 110 is communicatively coupled to a database 112 that contains a variety of operational data associated with the machines within the industrial facility including, without limitation, position and vibration data received from bearing X-probes and Y-probes, and bearing temperatures. The data is associated with a time of measurement. In the exemplary embodiment, database 112 is stored remotely from server system 102. In an alternate embodiment, database 112 may be decentralized. In the exemplary embodiment, a person can access database 112 via client systems 104 by logging onto server system 102.

The embodiments illustrated and described herein as well as embodiments not specifically described herein but within the scope of aspects of the disclosure, constitute exemplary means for recording, storing, retrieving, and displaying operational data associated with a machine. For example, server system 102, client systems 104, or any other similar computer device added thereto or included within, when integrated together, include sufficient computer-readable storage media that is/are programmed with sufficient computer-executable instructions to execute processes and techniques with a processor as described herein. Specifically, server system 102, client systems 104, or any other similar computer device added thereto or included within, when integrated together, constitute an exemplary means for recording, storing, retrieving, and displaying operational data associated with a machine.

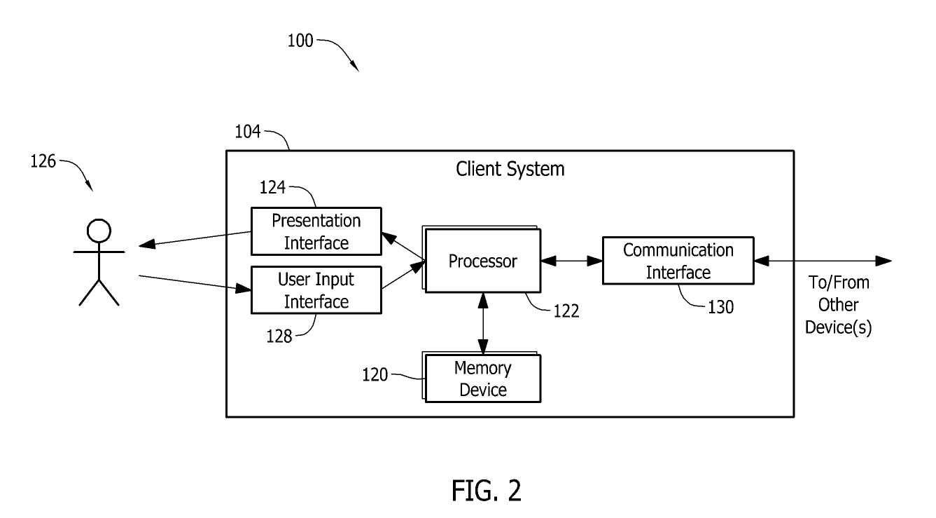

FIG. 2 is a block diagram of an exemplary configuration of a user computer device, e.g., client system 104, for use with monitoring system 100 that may be used to monitor and/or control the operation of a machine. Client system 104 includes a memory device 120 and a processor 122 operatively coupled to memory device 120 for executing instructions. In some embodiments, executable instructions are stored in memory device 120. Client system 104 is configurable to perform one or more operations described herein by programming processor 122. For example, processor 122 may be programmed by encoding an operation as one or more executable instructions and providing the executable instructions in memory device 120. Processor 122 may include one or more processing units (e.g., in a multi-core configuration).

In the exemplary embodiment, memory device 120 is one or more devices that enable storage and retrieval of information such as executable instructions and/or other data. Memory device 120 may include one or more computer readable media, such as, without limitation, dynamic random access memory (DRAM), static random access memory (SRAM), a solid state disk, and/or a hard disk. Memory device 120 may be configured to store a variety of operational data associated with the machines within the industrial facility including, without limitation, vibration data received from bearing X-probes and Y-probes, and bearing temperatures. In some embodiments, processor 122 removes or “purges” data from memory device 120 based on the age of the data. For example, processor 122 may overwrite previously recorded and stored data associated with a subsequent time and/or event. In addition, or alternatively, processor 122 may remove data that exceeds a predetermined time interval.

In some embodiments, client system 104 includes a presentation interface 124 coupled to processor 122. Presentation interface 124 presents information, such as a user interface and/or an alarm, to a user 126. For example, presentation interface 124 may include a display adapter (not shown) that may be coupled to a display device (not shown), such as a cathode ray tube (CRT), a liquid crystal display (LCD), an organic LED (OLED) display, and/or an “electronic ink” display. In some embodiments, presentation interface 124 includes one or more display devices. In addition, or alternatively, presentation interface 124 may include an audio output device (not shown) (e.g., an audio adapter and/or a speaker).

In some embodiments, client system 104 includes a user input interface 128. In the exemplary embodiment, user input interface 128 is coupled to processor 122 and receives input from user 126. User input interface 128 may include, for example, a keyboard, a pointing device, a mouse, a stylus, and/or a touch sensitive panel (e.g., a touch pad or a touch screen). A single component, such as a touch screen, may function as both a display device of presentation interface 124 and user input interface 128.

A communication interface 130 is coupled to processor 122 and is configured to be coupled in communication with one or more other devices, such as server system 102 (shown in FIG. 1), and another client system 104. Communication interface 130 performs input and output (I/O) operations with respect to such devices. For example, communication interface 130 may include, without limitation, a wired network adapter, a wireless network adapter, a mobile telecommunications adapter, a serial communication adapter, and/or a parallel communication adapter. Communication interface 130 may receive data from and/or transmit data to one or more remote devices. For example, a communication interface 130 of one client system 104 may transmit transaction information to communication interface 130 of another client system 104.

Presentation interface 124 and/or communication interface 130 are both capable of providing information suitable for use with the methods described herein (e.g., to user 126 or another device). Accordingly, presentation interface 124 and communication interface 130 may be referred to as output devices. Similarly, user input interface 128 and communication interface 130 are capable of receiving information suitable for use with the methods described herein and may be referred to as input devices.

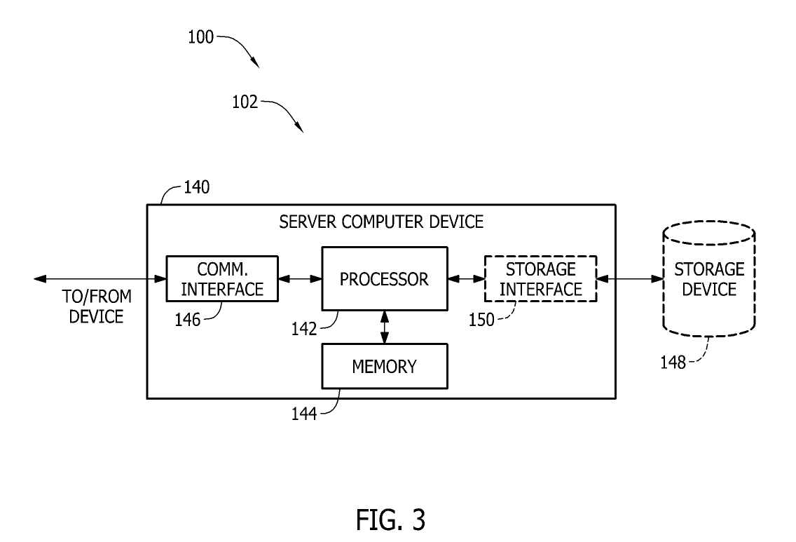

FIG. 3 is a block diagram of an exemplary configuration of a server computer device 140 that may be used to monitor and/or control the operation of a machine. More specifically, FIG. 3 is a block diagram of an exemplary configuration of server computer device 140 for use with monitoring system 100, and more specifically, server system 102 includes server computer device 140. Server computer device 140 may include, without limitation, database server 110 (shown in FIG. 1).

Server computer device 140 also includes a processor 142 for executing instructions. Instructions may be stored in a memory device 144, for example. Processor 142 may include one or more processing units (e.g., in a multi-core configuration). Memory device 144 may also include a variety of operational data associated with the machines within the industrial facility including, without limitation, position and vibration data received from bearing X-probes and Y-probes, and bearing temperatures.

Processor 142 is operatively coupled to a communication interface 146 such that server computer device 140 is capable of communicating with a device such as client system 104 or another server computer device 140. For example, communication interface 146 may receive requests from client system 104 via communications network 106 (shown in FIG. 1).

Processor 142 may also be operatively coupled to a storage device 148. Storage device 148 is any computer-operated hardware suitable for storing and/or retrieving data, such as, but not limited to, data associated with database 112. In some embodiments, storage device 148 is integrated in server computer device 140. For example, server computer device 140 may include one or more hard disk drives as storage device 148. In other embodiments, storage device 148 is external to server computer device 140 and may be accessed by a plurality of server computer devices 140. For example, storage device 148 may include multiple storage units such as hard disks and/or solid state disks in a redundant array of inexpensive disks (RAID) configuration. Storage device 148 may include a storage area network (SAN) and/or a network attached storage (NAS) system.

In some embodiments, processor 142 is operatively coupled to storage device 148 via a storage interface 150. Storage interface 150 is any component capable of providing processor 142 with access to storage device 148. Storage interface 150 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 142 with access to storage device 148.

Computer devices such as client system 104 and server computer device 140 may be grouped together in a computer system. For example, a computer system may be created by connecting a plurality of server computer devices 140 and/or client systems 104 to a single network. Alternatively, one or more computer devices operable by a single user may be considered a computer system.

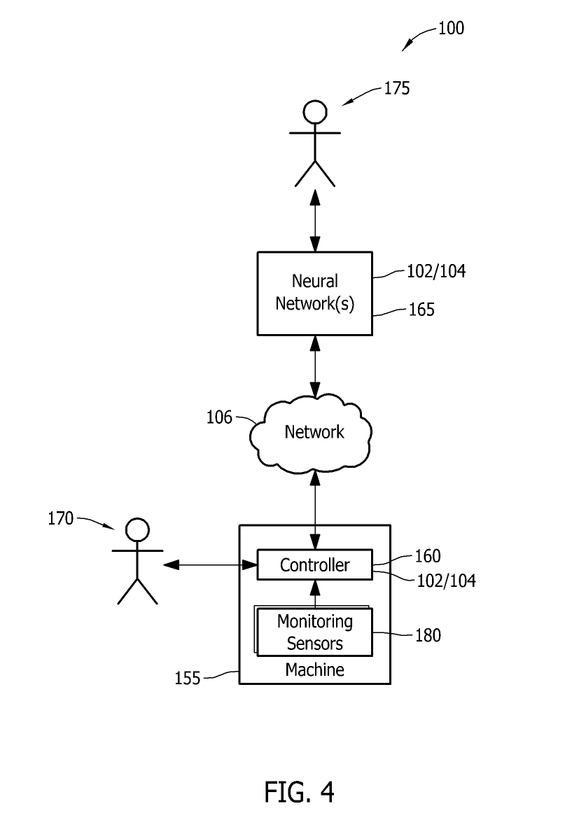

FIG. 4 is block diagram of monitoring system 100 that may be used to monitor and/or operate a machine 155. Machine 155 may be any industrial equipment for any industrial process, including, without limitation, any reciprocating device (e.g., internal combustion engines and compressors), a chemical process reactor, a heat recovery steam generator, a steam turbine, a gas turbine, a switchyard circuit breaker, and a switchyard transformer. Monitoring system 100 can be used in any larger industrial facility, including, without limitation, power generation stations (conventional and nuclear), oil refineries, chemical manufacturing plants, and food processing plants. In the exemplary embodiment, machine 155 is a portion of such a larger, integrated industrial facility (not shown) that may include, without limitation, multiple units of machine 155.

In the exemplary embodiment, monitoring system 100 includes a machine controller 160. Monitoring system also includes a learning method/model, or learning model, that includes, without limitation, neural networks, clustering analysis models, and support vector machine models. Support vector machine models are a type of supervised learning model. Clustering analysis models are a type of unsupervised learning model. Neural networks are a type of data-driven learning model. Alternatively, any computer-implemented models and/or modeling applications that enable operation of monitoring system 100 as described herein is used.

In the exemplary embodiment, and as used hereon, monitoring system 100 includes a computer-implemented learning model that is a neural network 165 coupled in communication with machine controller 160 via network 106. While certain operations are described below with respect to particular computing devices, e.g., client systems 104, it is contemplated that any computing device may perform one or more of the described operations. For example, controller 160 may perform all of the operations below.

In the exemplary embodiment, controller 160 and neural network 165 are each implemented in at least one of client systems 104 and/or server system 102. In the exemplary embodiment, each client system 104 and server system 102 are coupled to network 106 via communication interface 130 (shown in FIG. 2).

Controller 160 interacts with an operator 170 (e.g., via user input interface 128 and/or presentation interface 124, both shown in FIG. 2). For example, controller 160 may present information about machine 155, such as alarms, to operator 170. Neural network 165 interacts with a technician and/or engineer 175 (e.g., via user input interface 128 and/or presentation interface 124). For example, neural network 165 may present information, including, without limitation, raw data, derived data, and evaluation data, to technician/engineer 175. User 126 (shown in FIG. 2) may be either operator 170 or technician/engineer 175.

Machine 155 includes one or more monitoring sensors 180. In exemplary embodiments, monitoring sensors 180 collect operational measurements including, without limitation, bearing vibration and temperature readings. Monitoring sensors 180 repeatedly (e.g., periodically, continuously, and/or upon request) transmits operational measurement readings at the current time. For example, monitoring sensors 180 may produce an electrical current between a minimum value (e.g., 4 milliamps (ma)) and a maximum value (e.g., 20 ma). The minimum value is representative of an indication that no field current is detected and the maximum value is representative of an indication that the highest detectable amount of field current is detected. Controller 160 receives and processes the operational measurement readings.

In operation, and referring to FIGS. 1 through 4, in the exemplary embodiment, monitoring sensors 180 include an X-probe and a Y-probe (neither shown) mounted proximate to a bearing cap (not shown) and a resistance temperature detector (RTD) (not shown) mounted to extend through the bearing cap into an oil lubrication flow. The x-probe and y-probe measure bearing vibration by measuring relative position of the bearing cap to the probes. The RTD measures the bearing lubricating oil temperature. Monitoring sensors 180 transmit operational measurements in the form of signals (not shown) representative of the magnitudes of the variables being measured. The signals are assigned, or tagged with, a date and time of recording. Also, the signals, as transmitted, have a waveform with an amplitude and a frequency. The signals are transmitted from monitoring sensors 180 to controller 160 to facilitate operation, observation, and control of machine 155. The signals are also transmitted to database server 110 and are stored in database 112. In the exemplary embodiment, the signals are tagged with the operational mode, or condition of machine 155 at the time of data collection. Examples of operational conditions include, without limitation, completely shutdown, on turning gear, initial startup through synchronization, power generation, and shutdown to turning gear. Therefore, the signals, when loaded as data into data records within database 112, are sortable with respect to the operational condition of machine 155. Data is recorded and stored within database 112 for each operational condition, wherein the data is stored as historical data. The data stored as a function of each operational condition of machine 155 defines a portion of the data.

Also, in operation, at least one of client systems 104 and/or server system 102 includes executable instructions to collect at least a portion of the historical data from database 112, or directly from controller 160 as the data is received from monitoring sensors 180. Moreover, at least one of client systems 104 and/or server system 102 includes executable instructions and algorithms programmed within the available computer-readable storage media to perform a full spectrum analysis of these first operational measurements of machine 155 and generate a first full spectrum data set. The first full spectrum data set is transmitted to neural network 165. In the exemplary embodiment, only one neural network 165 is resident within monitoring system 100. Alternatively, any number of neural networks 165 may be resident that enables monitoring system 100 as described herein, including, without limitation, a neural network 165 for each operational condition of machine 155.

Further, in operation, the full spectrum analysis includes execution of a Fast Fourier Transformation (FFT) to transfer the recorded waveform data of the first operational measurements of machine 155 from the time domain to the frequency domain to generate the first full spectrum data set. The first full spectrum data set includes calculations of a plurality of elements and characteristics of the waveforms captured in the first operational measurements of machine 155 that are not available using a standard half-spectrum analysis. Such calculated elements and characteristics include, without limitation, full spectrum forward and reverse component amplitudes, full spectrum forward and reverse component frequencies, full spectrum forward and reverse orbit components, and at least one full spectrum forward and reverse order powers. As used herein, the terms “forward” and “reverse” are used to define, for example, orbit and casing motion, in relation to, for example, the direction of rotor rotation. In addition, such calculated elements and characteristics include derived information such as, without limitation, gaps, shaft center lines, and orbit shapes. Furthermore, such calculated elements and characteristics include derived waveform trend information such as, without limitation, a rate of change of spectral components, a frequency drift, and a phase drift.

Moreover, in operation, at least one of client systems 104 and/or server system 102 includes executable instructions to train/teach neural network 165 to associate a first portion of the first full spectrum data set with a first operating condition of machine 155. The first portion of the first full spectrum data set defines at least one first operational pattern of machine 155, specifically for that first operating condition. In addition, at least one of client systems 104 and/or server system 102 includes executable instructions to train neural network 165 to associate a second portion of the first full spectrum data set with a second operating condition of machine 155. The second portion of the first full spectrum data set defines at least one second operational pattern of machine 155, specifically for that second operating condition. Therefore, upon completion of training neural network 165, neural network 165 includes sufficient capabilities to define “normal” operational patterns for each operating condition of machine 155. Moreover, since “normal” operating conditions may vary with conditions that include, without limitation, environmental conditions due to weather and time of the year and recent operational history, a plurality of operational patterns may be generated within neural network 165.

In addition, for known “abnormal”, or “fault” operating conditions, the data in database 112 may be additionally tagged appropriately as a specific fault conditions for subsequent recognition as such an operational pattern by neural network 165. For example, a trip of turbomachine during roll-off from the turning gear during initial rotor acceleration may be identified as such for subsequent analysis. Therefore, using iterative recording and full spectrum analysis of data, consistent association of such data with operating condition-specific patterns, and loading neural network 165 with such patterns facilitate modeling machine 155 for each known operating condition. Therefore, monitoring system 100 at least partially generates a model of the bearing described above via the data directly recorded and the first full spectrum data set as a function of the operating conditions of machine 155. More specifically, the raw data and the full spectrum-analyzed data generated from the associated x-probe, y-probe, and RTD for vibration and temperature, respectively, facilitates generating an accurate model of the bearing.

Furthermore, in addition to the data described above, database 112 and neural network 165 may be provided with data associated with other information related to machine 155 and the components thereof, for example, the bearing described above. For example, if a particular model of machine 155 includes a bearing that either normally runs hot as compared to other bearings in the associated drive train, or the bearing experiences a relatively high vibration during startups proximate to a critical shaft speed, such information may be input into the model of machine 155 and the bearing to further define the accuracy of the models thereof within neural network 165. Therefore, such neural models may be partially generated by the raw and analyzed data, and may be combined with physics based models or deterministic logic to complete the operating condition-specific pattern modeling within neural network 165.

Moreover, in addition, screening filters of predetermined ranges may be established within monitoring system 100 at various points along the neural network training process described above. For example, some data may be an outlier to predetermined data ranges for selection within neural network 165 and be excluded therefrom.

Also, in operation, in addition to the historical data described above, monitoring sensors 180 transmit subsequent, real-time, or immediate operational measurements in the form of immediate signals representative of the immediate magnitudes of the variables being measured. The immediate signals are assigned, or tagged with, a date and time of recording. Also, the immediate signals, as transmitted, have a waveform. The immediate signals are transmitted from monitoring sensors 180 to controller 160 to facilitate operation, observation, and control of machine 155. The immediate signals are also transmitted to database server 110 and are stored in database 112. In the exemplary embodiment, the immediate signals are tagged with the operational mode, or condition of machine 155 at the time of data collection. Therefore, the immediate signals, when loaded as immediate data into data records within database 112, are sortable with respect to the operational condition of machine 155. The immediate data is recorded and stored within database 112 for each operational condition, wherein the immediate data may be stored as historical data. However, in contrast to the historical data, the immediate data is compared with the historical data records described above for each operational condition of machine 155 for which data records are maintained.

Further, in operation, at least one of client systems 104 and/or server system 102 includes executable instructions to collect at least a portion of the immediate data from database 112, or directly from controller 160 as the data is received from monitoring sensors 180. Moreover, at least one of client systems 104 and/or server system 102 includes executable instructions and algorithms programmed within the available computer-readable storage media to perform a full spectrum analysis of these second operational measurements of machine 155 and generate a second full spectrum data set in a manner, and with data content, similar to that described above for the first full spectrum data set. The second full spectrum data set is transmitted to neural network 165. Such operating condition-specific data facilitates directing neural network 165 to associate the second full spectrum data set with one of the first operating condition of machine 155 and the second operating condition of machine 155.

Moreover, in operation, at least one of client systems 104 and/or server system 102 includes executable instructions to direct neural network 165 to execute a comparison of the second full spectrum data set and the operating condition-specific pattern of machine 155 developed as described above. Neural network 165 is trained to “recognize” operational patterns for each operating condition and to further “recognize” when the immediate operational pattern differs substantially from the modeled operational pattern. For example, without limitation, predetermined parameters are established within neural network 165 for each component of machine 155. Also, neural network 165 is trained to determine which operational model of a plurality of operation models is closest to the immediate operating conditions and use that operational model as the baseline for comparison. In the event that the comparison between the immediate operational pattern and the closest matching modeled operational pattern exceeds at least one predetermined parameter, monitoring system 100 will notify at least one of operator 170 and technician/engineer 175 with one of an alert, a warning, or an alarm. Once operator 170 and/or technician/engineer 175 are notified, they will need to research the condition further using other methods and apparatus, for example, without limitation, visual inspections.

For example, if the bearing described above includes a higher-than-normal vibration indication for the x-probe, and the vibration readings from the y-probe and the RTD are well within established parameters for the immediate operating condition, neural network 165 will determine that a unique condition for the bearing exists and inform the operators appropriately. In some embodiments, parameters that include, without limitation, the magnitude and duration of the deviation of the immediate conditions from the model in neural network 165 may be set with low thresholds to provide the operators with sufficient time to respond to notifications. For example, rapidly rising oil temperatures from approximately 60 degrees Celsius (° C.) (140 degrees Fahrenheit (° F.)) to approximately 79.4° C. (175° F.) is typically an indication of a significant malfunction of a bearing that should be immediately investigated, and if necessary, responded to by the operators. In other embodiments, additional parameters that include, without limitation, an established relationship between the signals generated by related monitoring sensors 180 may permit higher thresholds for generating notifications. For example, a bearing that has a known unusually high temperature during acceleration of the rotor of machine 155 in combination with normal vibration readings from adjacent bearings and normal oil temperatures for all bearings may not generate a notification.

While the exemplary embodiment describes modeling of a portion of machine 155 that includes a rotor and bearings, monitoring system 100 may be used to model any portion of machine 155 including, without limitation, a gas turbine compressor and/or combustor and an electric power generator coupled to a gas turbine, a steam turbine, a wind turbine, and a diesel engine. Moreover, monitoring system 100 can be used with any machinery for any industrial process, including, without limitation, cracking processes in oil refineries, mixing processes in chemical manufacturing plants, packing processes in food processing plants, and combustion processes in fossil fuel-fired boilers.

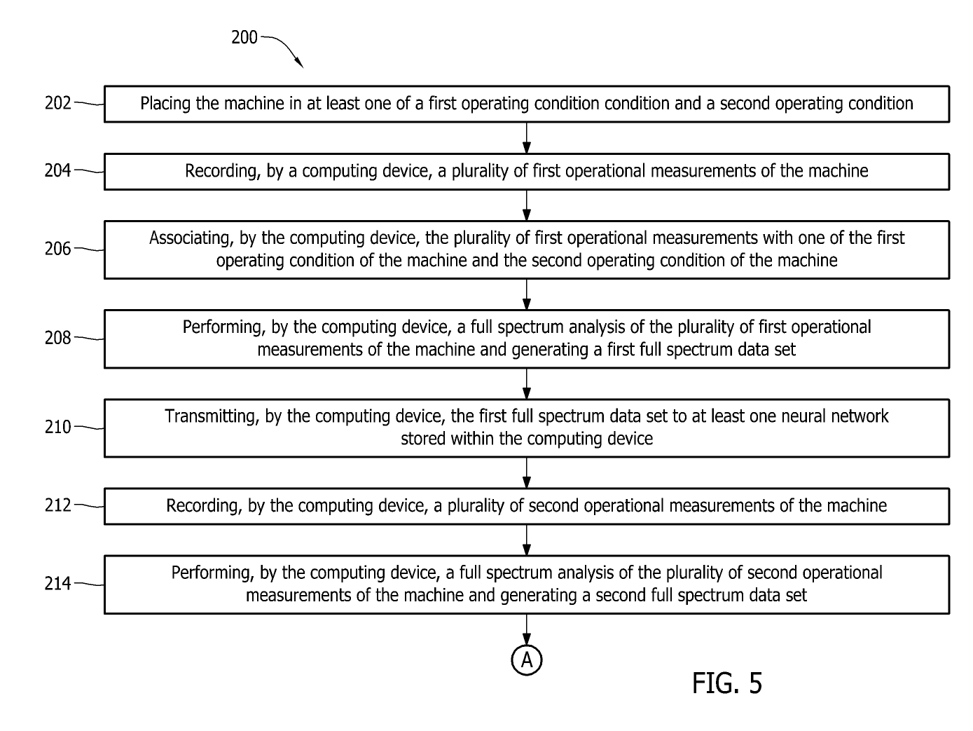

FIG. 5 is a flowchart of an exemplary method 200 that may be implemented to monitor and evaluate operation of machine 155 (shown in FIG. 4).

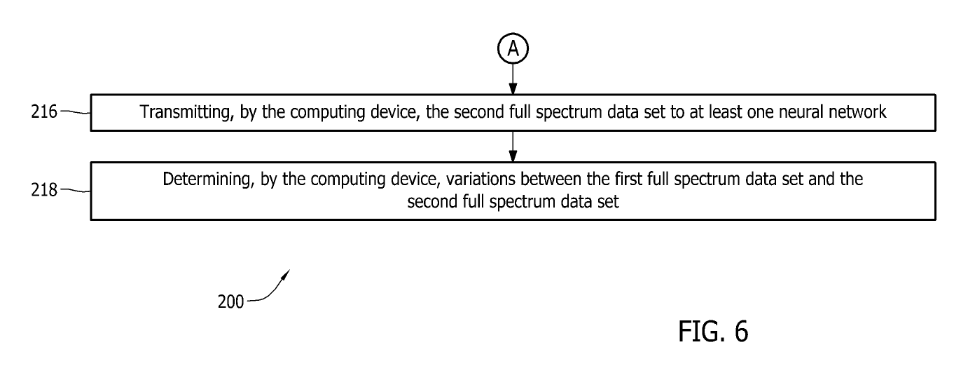

FIG. 6 is a continuation of the flowchart from FIG. 5. In the exemplary embodiment, machine 155 is placed 202 in at least one of a first operating condition and a second operating condition. A computing device, e.g., at least one of server system 102 and/or one of client systems 104 (both shown in FIG. 1), records 204 a plurality of first operational measurements of machine 155. At least one of server system 102 and/or one of client systems 104 associate 206 the plurality of first operational measurements with one of the first operating condition of machine 155 and the second operating condition of machine 155. Also, in the exemplary embodiment, at least one of server system 102 and/or one of client systems 104 perform 208 a full spectrum analysis of the plurality of first operational measurements of machine 155 and generate a first full spectrum data set. At least one of server system 102 and/or one of client systems 104 transmit 210 the first full spectrum data set to neural network 165 (shown in FIG. 4) stored within at least one of server system 102 and/or one of client systems 104. At least one of server system 102 and/or one of client systems 104 record 212 a plurality of second operational measurements of machine 155. Further, in the exemplary embodiment, at least one of server system 102 and/or one of client systems 104 perform 214 a full spectrum analysis of the plurality of second operational measurements of machine 155 and generate a second full spectrum data set. At least one of server system 102 and/or one of client systems 104 record 212 transmit the second full spectrum data set to neural network 165. At least one of server system 102 and/or one of client systems 104 determine 218 variations between the first full spectrum data set and the second full spectrum data set.

In contrast to known computer-implemented models of machines, the methods, systems, and apparatus described herein provide improved monitoring of operating machines. Specifically, in contrast to known computer-implemented models of machines, the methods, systems, and apparatus described herein enable improved identification, notification, and diagnosis of faults. More specifically, in contrast to known computer-implemented models of machines, the methods, systems, and apparatus described herein enable generating a model of a machine using existing monitoring hardware and a full spectrum analysis that extends analyzing collected waveform data beyond frequency data and amplitude data. Moreover, in further contrast to known computer-implemented models of machines, the methods, systems, and apparatus described herein enable importing the extended results of the full spectrum analysis into a learning model, e.g., a neural network. Furthermore, in contrast to known computer-implemented models of machines, the methods, systems, and apparatus described herein enable building more accurate models of machinery or/and faults. Such improved modeling of machines via importing data from a full spectrum analysis into a learning model, e.g., a neural network also facilitates using such models for anomaly detection and fault diagnostics by decreasing the analysis time and/or response time of the models, thereby facilitating an improved response time to anomalies and faults by the operators of the machine. Moreover, such improved modeling of machines facilitates decreasing the complexity of the models, and therefore decreasing the maintenance requirements of the models, as well as facilitating a better understanding of the relationships between the collected and generated data. Furthermore, using the existing data collection infrastructure to collect the raw operational data for the full spectrum analysis facilitates decreasing installation and implementation costs of the methods, systems, and apparatus described herein.

An exemplary technical effect of the methods, systems, and apparatus described herein includes at least one of (a) using existing sensor and monitoring hardware to collect and store operating data associated with a machine during each of the associated operating conditions of the machine; (b) using a full spectrum analysis to analyze the stored operating data; (c) importing the results of the full spectrum analysis into a learning model, e.g., a neural network to generate a computer-implemented model of the machine; (d) associating portions of the collected data and the data generated from the full spectrum analysis to the associated operating condition of the machine; (e) recording additional operational data during subsequent operation of the machine in the operating conditions previously defined; (f) comparing the additional operational data to the computer-implemented model; and (g) determining the presence of operational anomalies and machinery faults.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assemblies and methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

While the invention has been described in terms of various specific embodiments, those skilled in the art will recognize that the invention can be practiced with modification within the spirit and scope of the claims.

What is claimed is:

1. A system for monitoring a machine, said system comprising:
at least one memory device configured to store a plurality of operational measurements of the machine being monitored, wherein each operational measurement is associated with a time; and
at least one processor coupled with said at least one memory device, said at least one memory device comprising programmed computer instructions that instruct said at least one processor to:
record a first plurality of operational measurements of the machine;
perform a full spectrum analysis of the first plurality of operational measurements of the machine and generate a first full spectrum data set therefrom;
transmit the first full spectrum data set to at least one model stored within said at least one memory device; and
determine variations between the first full spectrum data set and a second full spectrum data set, wherein the second full spectrum data set is different from the first full spectrum data set.

2. A system in accordance with claim 1, wherein said at least one memory device further comprises programmed computer instructions that instruct said at least one processor to:
record a second plurality of operational measurements of the machine;
perform a full spectrum analysis of the second plurality of operational measurements of the machine and generate the second full spectrum data set therefrom; and
transmit the second full spectrum data set to said at least one model.

3. A system in accordance with claim 1, wherein said at least one memory device further comprises programmed computer instructions that instruct said at least one processor to perform a full spectrum analysis and generate a first full spectrum data set and a second full spectrum data set by calculating at least one of:
a full spectrum forward component amplitude;
a full spectrum reverse component amplitude;
a full spectrum forward component frequency;
a full spectrum reverse component frequency.
a full spectrum forward orbit component;
a full spectrum reverse orbit component;
at least one full spectrum forward order power;
at least one full spectrum reverse order power.

4. A system in accordance with claim 1, wherein said at least one memory device further comprises programmed computer instructions that instruct said at least one processor to perform a full spectrum analysis and generate a first full spectrum data set and a second full spectrum data set by calculating:
derived values comprising gaps, shaft center lines, and orbit shapes; and
derived waveform trends comprising at least one of a rate of change of spectral components, a frequency drift, and a phase drift.

5. A system in accordance with claim 1 further comprising at least one database server operatively coupled to at least one client system, wherein each of said at least one database server and said at least one client system comprise said at least one memory device and said at least one processor, wherein said at least one database server is operatively coupled to a database that includes a plurality of data records containing historical operating data of the machine, said historical operating data comprises the first full spectrum data set.

6. A system in accordance with claim 5, wherein said at least one memory device of said at least one database server and said at least one client system stores at least a portion of said at least one model, said at least one memory device comprising programmed computer instructions that instruct said at least one processor to:
associate a first portion of the first full spectrum data set with a first operating condition of the machine within said at least one model, wherein the first portion of the first full spectrum data set defines at least one first operational pattern of the machine; and
associate a second portion of the first full spectrum data set with a second operating condition of the machine within said at least one model, wherein the second portion of the first full spectrum data set defines at least one second operational pattern of the machine.

7. A system in accordance with claim 6, wherein said at least one memory device comprises programmed computer instructions that instruct said at least one processor to:
direct said at least one model to associate the second full spectrum data set with one of the first operating condition of the machine and the second operating condition of the machine;
direct said at least one model to execute a comparison of the second full spectrum data set and the at least one first operational pattern of the machine; and
notify an operator of said system when said comparison exceeds at least one predetermined parameter.

8. A system in accordance with claim 6, wherein said at least one model comprises:
a first model associated with the first operating condition of the machine; and
a second model associated with the second operating condition of the machine.

9. A method for monitoring a machine, said method comprising:
recording, by a computing device, a plurality of first operational measurements of the machine being monitored while the machine in a predetermined operating condition;
associating, by the computing device, the plurality of first operational measurements with the predetermined operating condition of the machine;
performing, by the computing device, a full spectrum analysis of the plurality of first operational measurements of the machine and generating a first full spectrum data set therefrom;
transmitting, by the computing device, the first full spectrum data set to at least one model stored within the computing device; and
determining, by the computing device, variations between the first full spectrum data set and a second full spectrum data set, wherein the second full spectrum data set is different from the first full spectrum data set.

10. A method in accordance with claim 9 further comprising:
recording, by the computing device, a plurality of second operational measurements of the machine while the machine is in the predetermined operating condition;
performing, by the computing device, a full spectrum analysis of the plurality of second operational measurements of the machine and generating a second full spectrum data set therefrom;
transmitting, by the computing device, the second full spectrum data set to the at least one model; and
directing, by the computing device, the at least one model to associate the second full spectrum data set with the predetermined operating condition of the machine.

11. A method in accordance with claim 9, wherein performing, by the computing device, a full spectrum analysis comprises calculating at least one of:
a full spectrum forward component amplitude;
a full spectrum reverse component amplitude;
a full spectrum forward component frequency;
a full spectrum reverse component frequency.
a full spectrum forward orbit component;
a full spectrum reverse orbit component;
at least one full spectrum forward order power;
at least one full spectrum reverse order power;
at least one gap value;
at least one shaft center line;
at least one orbit shape;
a rate of change of spectral components;
a frequency drift; and
a phase drift.

12. A method in accordance with claim 9, wherein recording, by a computing device, a plurality of first operational measurements of the machine comprises populating a database with a plurality of data records containing historical operating data of the machine, the historical operating data includes the first full spectrum data set.

13. A method in accordance with claim 9, wherein transmitting, by the computing device, the first full spectrum data set to the at least one model comprises:
associating, by the computing device, a first portion of the first full spectrum data set with a first operating condition of the machine within the at least one model, wherein the first portion of the first full spectrum data set defines at least one first operational pattern of the machine; and
associating, by the computing device, a second portion of the first full spectrum data set with a second operating condition of the machine within the at least one model, wherein the second portion of the first full spectrum data set defines at least one second operational pattern of the machine.

14. A method in accordance with claim 13, wherein determining, by the computing device, variations between the first full spectrum data set and the second full spectrum data set comprises:
directing, by the computing device, the at least one model to execute a comparison of the second full spectrum data set and the at least one first operational pattern of the machine; and
notifying, by the computing device, an operator of the machine when the comparison exceeds at least one predetermined parameter.

15. One or more non-transitory computer-readable storage media having computer-executable instructions embodied thereon, wherein when executed by at least one processor, the computer-executable instructions cause the at least one processor to:
communicate with at least one memory device to cause the at least one memory device to store and retrieve a plurality of first operational measurements of a machine, wherein each operational measurement is associated with a time, the machine being in a predetermined operating condition;
record a plurality of first operational measurements of the machine;
associate the plurality of first operational measurements with the predetermined operating condition of the machine;
perform a full spectrum analysis of the plurality of first operational measurements of the machine and generate a first full spectrum data set therefrom;
transmit the first full spectrum data set to at least one model stored within the at least one memory device; and
determine variations between the first full spectrum data set and a second full spectrum data set, wherein the second full spectrum data set is different from the first full spectrum data set.

16. The computer-readable storage media of claim 15, wherein the computer-executable instructions further cause the at least one processor to:
record a plurality of second operational measurements of the machine;
perform a full spectrum analysis of the plurality of second operational measurements of the machine and generate a second full spectrum data set therefrom;
transmit the second full spectrum data set to the at least one model; and
direct the at least one model to associate the second full spectrum data set with the predetermined operating condition of the machine.

17. The computer-readable storage media of claim 15, wherein the computer-executable instructions further cause the at least one processor to calculate at least one of:
a full spectrum forward component amplitude;
a full spectrum reverse component amplitude;
a full spectrum forward component frequency;
a full spectrum reverse component frequency.
a full spectrum forward orbit component;
a full spectrum reverse orbit component;
at least one full spectrum forward order power;
at least one full spectrum reverse order power;
a rate of change of spectral components;
at least one gap value;
at least one shaft center line;
at least one orbit shape;
a frequency drift; and
a phase drift.

18. The computer-readable storage media of claim 15, wherein the computer-executable instructions further cause the at least one processor to populate a database with a plurality of data records containing historical operating data of the machine, the historical operating data includes the first full spectrum data set.

19. The computer-readable storage media of claim 15, wherein the computer-executable instructions further cause the at least one processor to:
associate a first portion of the first full spectrum data set with a first operating condition of the machine in the at least one model, wherein the first portion of the first full spectrum data set defines at least one first operational pattern of the machine; and
associate a second portion of the first full spectrum data set with a second operating condition of the machine in the at least one model, wherein the second portion of the first full spectrum data set defines at least one second operational pattern of the machine.

20. The computer-readable storage media of claim 18, wherein the computer-executable instructions further cause the at least one processor to:
direct the at least one model to execute a comparison of the second full spectrum data set and the at least one first operational pattern of the machine; and
notify an operator of the machine when the comparison exceeds at least one predetermined parameter.
